(19) United States
(12) Patent Application Publication
(10) Pub. No.: US 2007/0258718 A1
(43) Pub. Date: Nov. 8, 2007

(54) Method and system for extending internet protocol remote control to non-internet protocol devices

(75) Inventors: Jeff Furlong, Grand Bay - Westfield (CA); Jared D. McNeill, Saint John (CA); Robert J. Beaton, Apohaqui (CA)

Correspondence Address: KRAMER & AMADO, P.C., 1725 DUKE STREET, SUITE 240, ALEXANDRIA, VA, 22314, US

(73) Assignee: ALCATEL, Paris (FR)

(21) Appl. No.: 11/418,133

(22) Filed: May 5, 2006

(51) Int. Cl. H04B 10/00

(52) U.S. Cl. 398/106

(57) ABSTRACT

A method for controlling an infrared radiation (“IR”) based consumer electronics (“CE”) device with a wireless Internet Protocol (“IP”) based remote control unit, the method comprising: receiving an IP message from the remote control unit through an IP receiver of an IP remote control extender system, the IP message for controlling a function of the CE device, the IP receiver for receiving IP messages over a wireless IP network; determining from the IP message a respective IR message for controlling the function; and, sending the respective IR message to the CE device through an IR transmitter of the IP remote control extender system, the IR transmitter for sending IR messages over a wireless IR link, whereby a user of the remote control unit may control the function of the CE device.

### FIELD OF THE INVENTION

This invention relates to Internet Protocol (“IP”) based remote control units, and more specifically, to a method and system for extending IP based remote control to non-IP based devices (e.g., infrared radiation (“IR”) based devices, radio frequency (“RF”) based devices, etc.).

### BACKGROUND OF THE INVENTION

The long-promised dream of a home-wide network that allows gadgets to seamlessly interconnect is becoming a reality. As personal electronic equipment (both mobile and home-based), also known as consumer electronics (“CE”), evolves, the industry trend is to enable customers with digital home networks that are simple and affordable for users so the connected home experience becomes a mainstream experience for users and great opportunity for the industry. Products based on a new home networking specification backed by some of the world's largest consumer electronics and computer companies are already on store shelves. The specification was drawn up by a group called the Digital Living Network Alliance (“DLNA”).

Reaching a cross-industry consensus, DLNA has defined two major components, the media server and the media-rendering device, that are necessary for seamless interoperability among devices accessing a home network. The interoperability guidelines drafted by DLNA define the design principles necessary to move content from one CE device, personal computer (“PC”), or mobile product to another in a wired or wireless home network. Part of the reason for the fast pace of preparing the specification is its reliance on existing standards; DLNA uses widely accepted specifications to encourage adoption within CE, PC, and mobile product manufacturing industries. The first version calls for a home network based on wired or wireless Ethernet and running the Internet Protocol (“IP”) version 4 (“IPv4”), the transmission control protocol (“TCP”), and the user datagram protocol (“UDP”). Media is carried across the network using the hypertext transfer protocol (“HTTP”) and discovery. The wireless fidelity (“Wi-Fi”) protocol (which is IEEE 802.11 based) is also used for enabling wireless interconnectivity.

A new version of the DLNA specification intends to cover a number of optional media formats, including GIF, PNG and TIFF images, MP3, Windows Media Audio, AC-3, AAC and ATRAC3, plus audio and the MPEG4 Part 2, MPEG4 Part 10, and Windows Media Video 9 video formats. The optional formats will mean no transcoding is required in the case that two devices support MP3, for example. The devices will still be required to support the mandatory formats so they can exchange data with devices that don't support the optional format in question.

Control and management of connected devices is accomplished with the universal plug and play (“UPnP”) standard. Unlike the “plug-and-play” technology that enables users to attach devices to a personal computer, UPnP is a standard that uses Internet and Web protocols to enable devices such as PCs, peripherals, intelligent appliances, and wireless devices to be plugged into a network and automatically know about each other. UPnP technology is supported on essentially any operating system and works with essentially any type of physical networking media, wired or wireless, providing maximum user and developer choice and great economics. Furthermore, UPnP architecture enables vendor control over device user interface and interaction using the web browser.

UpnP networking also enables a distributed, open architecture that enables seamless proximity networking in addition to control and data transfer among networked devices in the home, office, and everywhere in between. Given an IP address, the first step in UPnP networking is discovery. When a device is added to the network, the UPnP discovery protocol allows that device to advertise its services to control points on the network. Similarly, when a control point is added to the network, the UPnP discovery protocol allows that control point to search for devices of interest on the network. The fundamental exchange in both cases is a discovery message containing a few, essential specifics about the device or one of its services, e.g., its type, identifier, and a pointer to more detailed information. The UPnP discovery protocol is based on the simple service discovery protocol (“SSDP”). The UPnP description of a device is expressed in extensible mark-up language (“XML”) and includes vendor-specific, manufacturer information, a list of any embedded devices or services with the respective commands and parameters, as well as uniform resource locators (“URLs”) for control, eventing, and presentation.

Device interoperability in a digital home network is however only the first step. Another important step is getting the devices to speak the same language, which in multimedia terms means to exchange data in the same format. Products can use other formats internally but must be able to transcode them to one of the base formats for interconnection purposes. In the first version of the DLNA specification the JPEG image, Liner PCM audio, and MPEG2 video protocols have been set as a common base.

UpnP control messages are also expressed in XML using the simple object access protocol (“SOAP”). If a CE device has a URL for presentation, then the control point can retrieve a page from this URL, load the page into a web browser, and depending on the capabilities of the page, allow a user to control the device and/or view device status. The degree to which each of these can be accomplished depends on the specific capabilities of the presentation page and device.

In addition, in today's digital world, setting common formats for both interconnection and files is not enough. As users of online music download services have already discovered, digital rights management (“DRM”) systems can stop content sharing cold even if the files are based on the same format. One system, called the digital transmission content protection/Internet protocol (“DTCP/IP”), is being developed by several industry leaders. It is intended to protect content as it is transmitted across an IP network like that used by DLNA products. Developers of the system are working with DRM owners on transcoding that would also allow sharing of content between devices that support different DRM systems—something that isn't possible at present.

However, to date there is no adequate remote control unit that enables user control of multiple CE devices in the digital home network, specifically one that is universal, inexpensive, enables remote control, and does not need to be in the line-of-sight of the device it is controlling.

While traditional remote control units that use infrared radiation (“IR”) are inexpensive, however, they require that the controlled device be enabled with an IR receiver and that line-of-sight be maintained. In addition, since CE devices typically have their own IR control codes, a separate remote control is needed for each. The universal remote control units available today are rather complex, control only a limited number of devices, and still require line-of-sight.

Line-of-sight is not required by ultra high frequency (“UHF”) remote control units available today. However, these devices are expensive and are limited in the distance that they can be from the CE device they are intended to control (i.e., they may require a remote extender). Also, UHF remote control units are not universal, since not all CE devices are equipped with UHF receivers.

In addition, traditional remote control units are typically not provided with visual means (e.g., a display) for viewing the status of a respective CE device currently being controlled nor for transmitting commands using the display. This type of control is possible only for CE devices that have an URL for presentation, but not from the remote.

With respect to remote control units in general, United States Patent Application Publication No. 2005/0110909 by Staunton, et al. (“Staunton”), entitled “Digital Remote Control Device”, describes a remote control device with a display. This remote control is used only for downloading video and/or supplemental textual data received by a television (“TV”) receiving apparatus or set. However, this remote controller is not universal, in that is able to communicate only with TV sets, requires a specific system controller built in the TV set, and is only enabled to download data from the TV set.

In addition, United States Patent Application Publication No. 2003/0120831 by Dubil, et al. (“Dubil”), entitled “Activity-Based Remote Control Device”, describes a remote controller with a display that provides commands and options based on the configuration of components in a user's environment, and based on a defined user activity. The functionality of interface buttons shown on the remote's display changes depending on the control application, i.e. the remote is system and activity aware. However, in order for this remote to function accordingly, an application is provided for a personal PC where the user is required to pre-configure user profiles and activities in a table format. Once this is completed, the application compiles the table and then is available to download to the remote control device. The disadvantage of this is that the consumer is required to have a PC and be able to run/use the software application to configure the remote's user profiles and activities. As such, this remote control device is not targeted for the average consumer.

In addition, United States Patent Application Publication No. 2004/0090984 by Saint-Hilaire, et al. (“Saint-Hilaire”), entitled “Network Adapter for Remote Devices”, describes a network adapter device that can provide a remote host with access to different peripherals connected to the network adapter device. Such peripherals can include, for example, universal serial bus (“USB”) peripherals and/or consumer electronic peripherals.

Furthermore, United States Patent Application Publication No. 2005/0076363 by Dukes, et al. (“Dukes”), entitled “System and Method for Navigation of a Multimedia Interface”, describes a system and method for providing and experiencing broadcast and non-broadcast content. This system and method provides a user with the ability to navigate a multimedia interface which simultaneously displays both broadcast and non-broadcast data. In one embodiment, a user is able to navigate television programming options, and selectively view detailed information on a selected programming option. In another embodiment, this detailed information includes at least one of critic information, actor information and related-content recommendations.

Thus, while systems such as those provided by Staunton, Dubil, Saint-Hilaire, and Dukes may provide various methods for remote control of CE devices, they do not provide adequate means for universal control of any type of CE device that may be present in the home, whether the device is connected to an IP network or not. Thus, there remains a need for a universal remote control unit that is inexpensive and does not need to be in the line-of-sight of the CE device it is controlling.

A need therefore exists for an improved method and system for remotely controlling both IP based and non-IP based CE devices. Accordingly, a solution that addresses, at least in part, the above and other shortcomings is desired.

### SUMMARY OF THE INVENTION

According to one aspect of the invention, there is provided a method for controlling an infrared radiation (“IR”) based consumer electronics (“CE”) device with a wireless Internet Protocol (“IP”) based remote control unit, the method comprising: receiving an IP message from the remote control unit through an IP receiver of an IP remote control extender system, the IP message for controlling a function of the CE device, the IP receiver for receiving IP messages over a wireless IP network; determining from the IP message a respective IR message for controlling the function; and, sending the respective IR message to the CE device through an IR transmitter of the IP remote control extender system, the IR transmitter for sending IR messages over a wireless IR link, whereby a user of the remote control unit may control the function of the CE device.

In the above method, the wireless IP network may be an IEEE 802.11 based wireless fidelity (“Wi-Fi”) network. The IR based CE device may be a radio frequency (“RF”) based CE device, the IR transmitter may be a RF transmitter, and the IR message may be a RF message. The step of determining may further include using content of the IP message to look up the IR message from a table of IP messages, IR messages, and IR based CE device identifiers, the table being stored in a memory of the IP remote control extender system. The content of the IP message may include an identifier for the CE device and an identifier of the function. The method may further include populating the table by discovering the IR based CE device identifiers from the IP based remote control unit using an IP based discovery protocol over the wireless IP network. The IP based discovery protocol may be a universal plug and play (“UPnP”) protocol. The method may further include populating the table by discovering the IR based CE device identifiers from each IR based CE device using an IR based discovery algorithm over the wireless IR link. The IP remote extender system may be included in a set-top box (“STB”). And, the IR based CE device may be one or more of a set-top box (“STB”), a stereo system, a video recorder (“VCR”), a digital video disk (“DVD”) player, a compact disk (“CD”) player, a stereo receiver, a tape deck, and a television (“TV”).

In accordance with further aspects of the present invention there is provided an IP remote control extender system, a method for adapting this system, as well as articles of manufacture such as a computer readable medium having program instructions recorded thereon for practising the method of the invention.

### BRIEF DESCRIPTION OF THE DRAWINGS

Further features and advantages of the embodiments of the present invention will become apparent from the following detailed description, taken in combination with the appended drawings, in which:

FIG. 1 is a block diagram illustrating a digital home network using an IP remote control unit in accordance with an embodiment of the invention;

FIG. 2 is a screen capture illustrating a view displayed on the display screen of an IP remote control unit in accordance with an embodiment of the invention;

FIG. 3 is a block diagram illustrating an IP remote control unit and a digital home network in accordance with an embodiment of the invention;

FIG. 4 is a block diagram illustrating an exemplary digital home communications system equipped with an IP remote control extender system in accordance with an embodiment of the invention;

FIG. 5 is a block diagram illustrating an IP remote control extender system in accordance with an embodiment of the invention; and,

FIG. 6 is a flow chart illustrating operations of modules within the memory of an IP remote control extender system for controlling an infrared radiation (“IR”) based consumer electronics (“CE”) device with a wireless Internet Protocol (“IP”) based remote control unit, in accordance with an embodiment of the invention.

It will be noted that throughout the appended drawings, like features are identified by like reference numerals.

### DETAILED DESCRIPTION OF THE PREFERRED EMBODIMENTS

In the following description, details are set forth to provide an understanding of the invention. In some instances, certain software, circuits, structures and techniques have not been described or shown in detail in order not to obscure the invention. The term “data processing system” is used herein to refer to any machine for processing data, including the IP remote control extender system, IP remote control units, set-top boxes, personal computers (“PCs”), and servers that may be described herein. The present invention may be implemented in any computer programming language provided that the operating system of the data processing system provides the facilities that may support the requirements of the present invention. Any limitations presented would be a result of a particular type of operating system or computer programming language and would not be a limitation of the present invention.

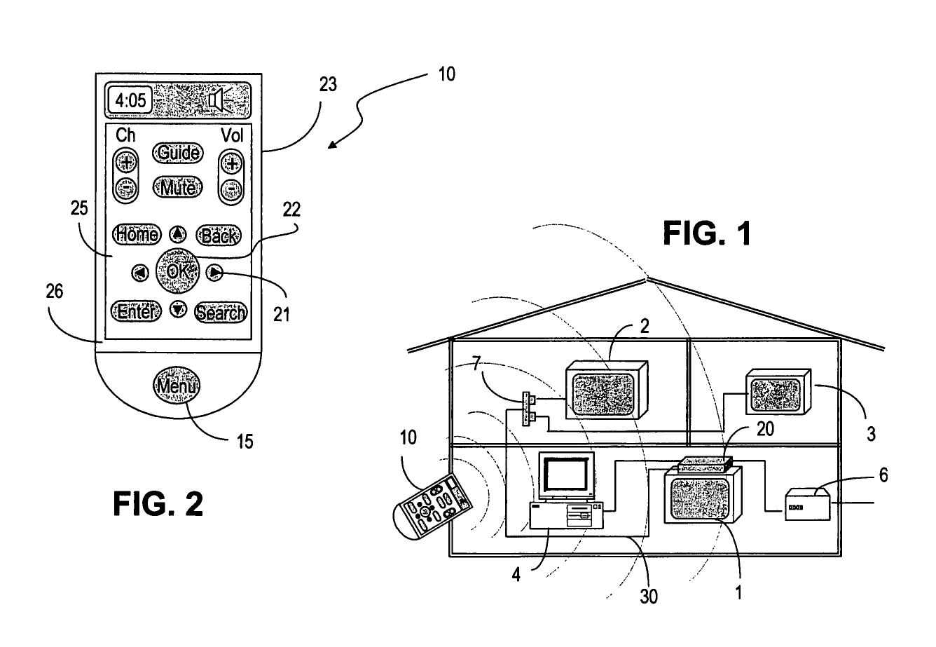

FIG. 1 shows an example of a digital home network 30 for in-home distribution of multimedia (e.g., video, audio, data, etc.) content, that connects a plurality of video, audio or data terminals such as TVs 1, 2, 3, computers (e.g., PCs) 4, etc. (collectively referred to as “devices”), communicatively connected to a set-top box (“STB”) 20. The in-home network 30 may also include splitters 7 as needed, for attaching all the devices to a specific port of the STB 20. FIG. 1 also shows that the STB 20 is connected to a communication network over a gateway 6, using any adequate technology (e.g., digital subscriber line (“DSL”), fiber-to-the-home (“FTTH”), etc.) for receiving any multimedia entertainment content of interest to the respective subscriber.

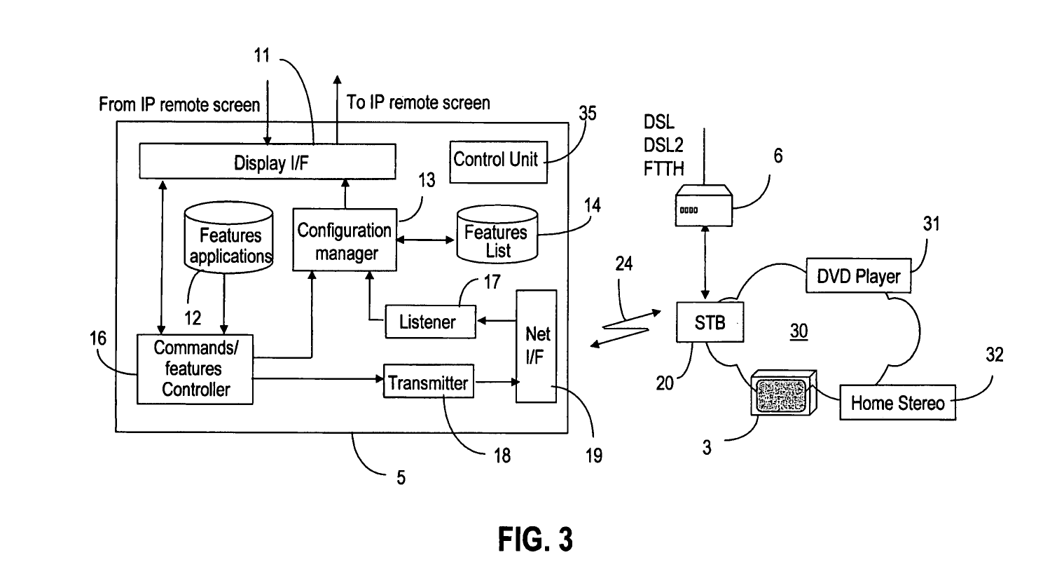

The IP remote control unit 10 according to the invention obtains an IP address from the home gateway 6 and uses a wireless network 24 (see FIG. 3) within the home to communicate with devices. In this case the IP remote 10, once an IP address is obtained, uses UPnP to discover the STB 20 and gathers all relevant information on how to control the STB 20. Once this is obtained, the IP remote 10 is now configured to control the STB 20.

FIG. 2 shows an example of one embodiment of the IP remote 10 according to the invention. In the example of FIG. 2, the IP remote 10 has a flat housing 23 for the electronics unit 5 (see FIG. 3), and a large display screen 25. Also, the IP remote 10 of the example of FIG. 2 has a menu button 15 for enabling the user to view and select a device of interest on screen 25.

It is to be noted that the shape of the housing 23 is not relevant to the invention as long as it can accommodate the screen 25 on its front face 26. In addition, the functionality of the menu button 15 is not limited to device selection, rather, other menus may be displayed to enable user selection of a command or feature. The term “view” is used herein to identify a particular graphic shown on the screen 25 of the IP remote 10. The term “features” (or “command”) is used to specify the controls applicable to the various devices. The virtual buttons or icons (e.g., 21, 22) appearing on the display 25 of the IP remote 10 are referred to as “controls”. The screen 25 may be a touch sensitive screen.

Once a view has been selected, the features/controls 21, 22 available for the respective view are displayed on screen 25. The screen may display a device-specific view with the controls 21, 22 available for a respective device. The user may press any button 21, 22 for controlling the operation of the respective device. The IP remote 10 has the ability to send key commands to devices over a secured TCP/IP network. For example, the IP remote 10 of FIG. 2 displays the control buttons for a STB 20, whereby the user may scan channels, request viewing of the program guide, increase/decrease the volume, etc.

Each device 1, 2, 3, 4, 20 has a specified dedicated port through which it will listen and retrieve key commands. The content of the key command message will contain the device ID (or name), the key command, and any extra options that are supported by the device. A key command may include a value, a word representing the command (i.e., RECORD), or a string of multiple commands (i.e., RECORD CHANNEL 4 AND TURN OFF TV).

The screen 25 may also show a more generic view for enabling the user to request one or more devices connected over the network to perform a sequence of functions/commands involving operation of a plurality of devices. On such a generic view (not shown), a user may send multiple commands to multiple devices, such as for example “STB1 RECORD CHANNEL 4 AND STB2 RECORD CHANNEL 5 AND STEREO TUNE TO 94.1FM”. The remote 10 may also be programmed to perform a succession of operations involving one or more devices. For example, STB1 RECORD CHANNEL 4 AND TURN OFF TV. In addition, the commands may be timed if needed.

It is to be noted that since the IP remote 10 is driven by a software application (or modules), it allows for easy upgrades and can easily support multi-decode set-top boxes, by adequately re-configuring the respective interface. Also, since any type of screen can be generated, the IP remote 10 provides a virtually unlimited degree of control for the virtually unlimited number and type of CE devices that it can control. According to one embodiment, a virtual remote control is provided that can be run on a laptop computer, PC, etc. As well, since it communicates with the STB 20 over a wireless link 24, no line-of-sight is required, the user being able to control the devices on the home network 30 from any point within the home or neighbourhood.

As indicated above, the IP remote 10 is preferably based on the DLNA specification, which means it is able to auto-discover other devices and detect what features are supported by each of these devices. Auto-configuration can be performed through UPnP. When connected to the home network 30, it populates a list of all devices that are connected to the network, and it provides the ability to select which device to control.

The IP remote 10 can also be manually configured to support any devices that are not part of or follow the DLNA specification. Preferably, the IEEE 802.11b standard (or IEEE 802.11 family of standards) is used as the primary choice for network connectivity, but, the IP remote 10 may be configured to work on any network.

FIG. 3 shows a block diagram of the IP remote 10 and home network 30 according to an embodiment of the invention. The IP remote 10 includes an interface 11 for the IP remote's display 25, which is preferably a liquid crystal display (“LCD”) interface. The interface 11 converts the data received from the electronics unit 5 into graphic objects representing the buttons 21,22 on the screen 25, and also translates the commands activated or entered by the user through the screen 25 into control signals. A network interface 19 sends commands entered by the user over a wireless network 24 to the home network 30. A listener 17 operates to discover the devices 20, 3, 31, 32 connected to the network 30. Once a device is discovered, the listener 17 transmits the device identity to a configuration manager 13 that configures the controls available for the respective device, by consulting a memory 14. The memory 14 maintains a list of all commands/ features (i.e., a features list) available for all devices that may be connected over the home network 30. The configuration manager 13 uses this list for preparing the view for the respective device, by associating the commands/features with the respective device identity collected by the listener 17.

For example, if the user selects the STB 20 on the menu view of the IP remote 10, the configuration manager 13 recognizes the device 20 as being a STB, collects from the list 14 all controls/features applicable to the STB 20, and prepares the view shown in the example of FIG. 2. It is to be noted that it is also possible to have different views for different types (or models) of STBs (e.g., a personal video recorder (“PVR”) model, a non-PVR model, etc.). In this case, the listener 17 must also provide the device type (or model) to the configuration manager 13.

The IP remote 10 also includes a commands/features controller 16 that receives the respective control data from the screen 25 over the interface 11 and executes the operations necessary for the respective control/feature. A database 12 maintains a repository for all subroutines (i.e., features applications) corresponding to the operations that can be performed by the devices. Once the command is identified and the application is extracted from memory 12, the commands controller 16 sends the respective command (or sequence of commands or multiple commands) to the device (or devices) using a transmitter 18, which transmits (or sends) the key command(s) over the home network 30 (i.e., via software) to the specified device. Overall operation of the IP remote 10 is coordinated by the control unit 35.

Now, the present invention provides a method and system for enabling non-IP based devices (i.e., devices lacking IP connectivity) to be controlled with an IP remote control 10. The present invention provides an IP remote control extender system that is used as a gateway for receiving IP based commands from the IP remote 10 and for translating these IP based commands into IR and/or RF based commands for devices that do not support IP, such as stereos, DVD players, etc. This allows the IP remote control 10 to be used with a wider range of CE devices, home electronics systems, and home entertainment systems.

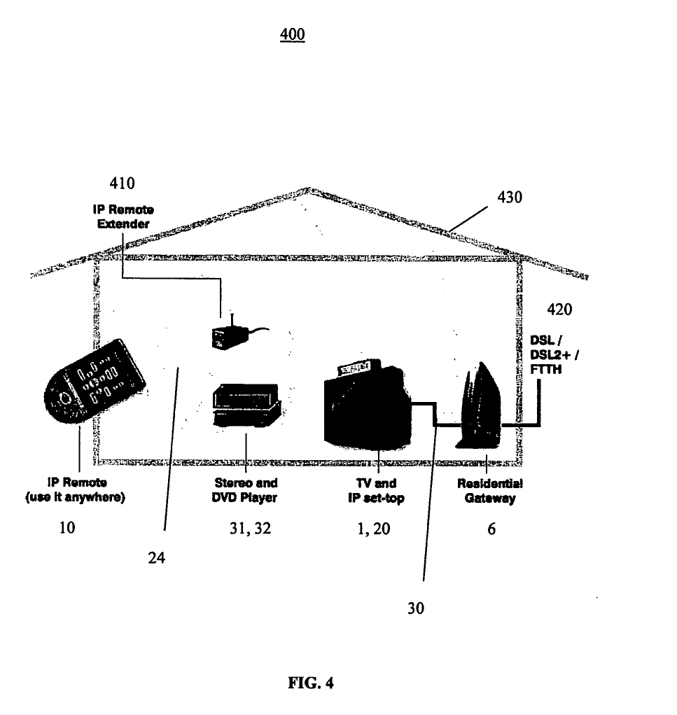

FIG. 4 is a block diagram illustrating an exemplary digital home communications system 400 equipped with an IP remote control extender system 410 in accordance with an embodiment of the invention. The communications system 100 includes an IP remote control unit 10, an IP remote control extender system 410, a set-top box 20, a television (“TV”) 1, a residential gateway 6, a stereo 32, and a digital video disk (“DVD”) player 31. In FIG. 4, the set-top box (“STB”) 20 and TV 1 are configured for direct control by the IP remote control 10. The STB 20 and TV 1 are IP based devices. The stereo 32 and DVD player 31, on the other hand, are not configured for direct control by the IP remote control 10. That is, the stereo 32 and DVD player 31 are non-IP based devices. The stereo 32 and DVD player 31 may be configured for control by an IR or RF based remote control unit (not shown). The set-top box 20, TV 1, and residential gateway 6 are coupled by a wired network 30. Optionally, the IP remote control extender 410 may also be coupled to the wired network 30. The gateway 6 is coupled to an external network 420 such as a DSL, DSL2+, or FTTH network. The gateway 6 relays information (e.g., IP packets, etc.) from the external network to the wired network 30. The IP remote control 10 is coupled to the wired network 30, set-top box 20, television 1, and IP remote control extender 410 over a wireless network 24 within the home 430.

Thus, FIG. 4 illustrates an example home distribution system 400 for multimedia content in which the IP remote 10 and IP remote control extender 410 of the present invention may be used. The STB 20 runs a software client or module that communicates with the IP remote 10 to receive control instructions from a user of the IP remote for controlling devices, such as a TV 1, a PC, etc., that are communicatively connected (i.e., by network 30 and/or 24) to the STB 20. The IP remote control extender 410 is used as a gateway that receives commands from the IP remote 10 and translates them to IR and/or RF commands for devices that do not support IP, such as the stereo 32, DVD player 31, etc.

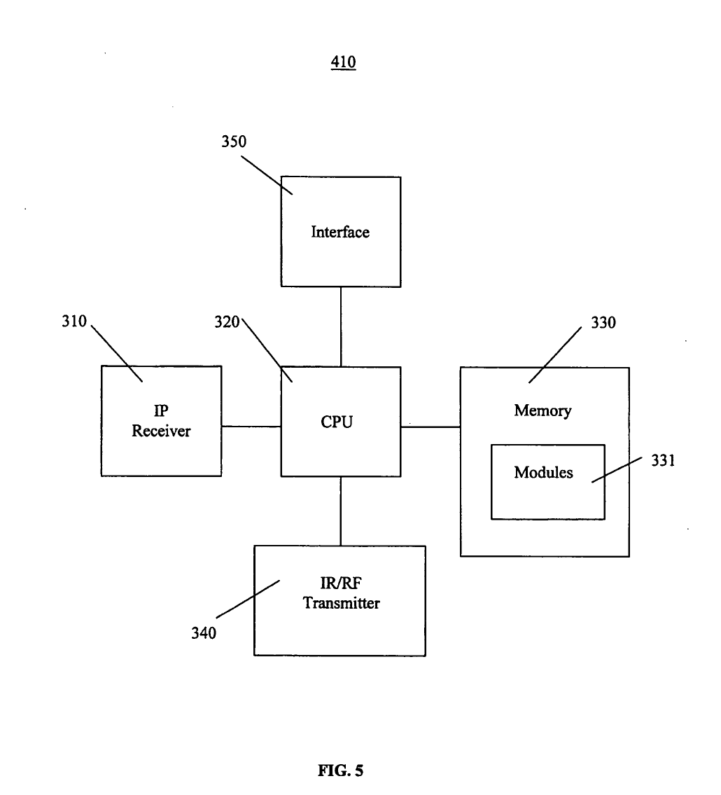

FIG. 5 is a block diagram illustrating an IP remote control extender system 410 in accordance with an embodiment of the invention. The IP remote control extender system 410 includes a central processing unit (“CPU”) 320, memory 330, an IP receiver 310, and an IR and/or RF transmitter 340. Optionally, the system 410 may include an interface device 350, an input device (not shown), and a display (not shown). The CPU 320 may include dedicated coprocessors and memory devices. The memory 330 may include RAM, ROM, disk devices, and databases. The IP receiver 310 is for receiving IP based control commands from the IP remote 10 over the wireless network 24. The IR and/or RF transmitter 350 is for transmitting IR and/or RF based control commands to non-IP based devices such as the stereo 32 and DVD player 31. The IP receiver 310 and IR/RF transmitter 350 may be coupled to a suitable antenna (not shown). The interface device 350 may include a network connection (e.g., an IP based network 30 connection and/or a wireless network 24 connection). The input device 310 may include a keyboard, a mouse, a trackball, a remote control unit, or a similar device. And, the display 340 may include a computer screen, television screen, terminal device, or a hardcopy producing output device such as a printer or plotter. The CPU 320 of the system 410 is operatively coupled to memory 330 which stores an operating system (not shown) for general management of the system 410. The IP remote control extender system 410 may be adapted for communicating with other data processing systems (e.g., 20, 6) over a network 24, 30 via the interface device 350. The IP remote control extender system 410 has stored therein data representing sequences of instructions which when executed cause the method described herein to be performed. Of course, the system 410 may contain additional software and hardware a description of which is not necessary for understanding the invention.

Thus, IP remote control extender system 410 includes computer executable programmed instructions for directing the system 410 to implement the embodiments of the present invention. The programmed instructions may be embodied in one or more hardware modules or software modules 331 resident in the memory 330 of the system 410. Alternatively, the programmed instructions may be embodied on a computer readable medium (such as a CD disk or floppy disk) which may be used for transporting the programmed instructions to the memory 330 of the system 410. Alternatively, the programmed instructions may be embedded in a computer-readable signal or signal-bearing medium that is uploaded to a network by a vendor or supplier of the programmed instructions, and this signal or signal-bearing medium may be downloaded through an interface (e.g., 350) to the system 410 from the network by end users or potential buyers.

In operation, the IP remote extender 410 receives IP based commands from the IP remote 10 at its IP receiver or input 310, translates the commands to equivalent IR or RF based commands through operations of modules 331 stored in its memory 330 and/or CPU 320, and transmits the IR or RF based commands through its IR or RF transmitter or output 340 to IR or RF based devices 31, 32. In so doing, the IP remote extender 410 works over an IP network 24,30 to control any IR and/or RF device (e.g., 31, 32).

According to one embodiment, the IP remote control extender system 410 is a stand-alone device that may be incorporated in a digital home communications system 400. According to another embodiment, the IP remote control extender system 410 may be incorporated within a STB 20 in a digital home communications system 400.

According to one embodiment, the IP remote extender 410 is provided with the ability (i.e., via software modules 331) to learn equivalent IR/RF key codes of all devices (e.g., 31, 32).

According to one embodiment, an IP remote extender 410 may be provided in each room of a home 430 served by a digital home communications system 400. As the IP remote extender 410 has the flexibility to control many devices (e.g., 31, 32 ), only one extender 410 is required per room.

According to one embodiment, the IP receiver 310 of the IP remote extender 410 includes a built in IEEE 802.11b chipset for receiving IP key commands from the IP remote 10.

According to one embodiment, the IP remote extender 410 includes a software stack (e.g., 331) for learning about local devices 31,32 through a series of tests and for storing equivalent IR/RF commands in its memory 330 (e.g., non-volatile random access memory (“NVRAM”)).

According to one embodiment, the IP remote extender 410 may receive updates and/or upgrades to its software stack 331 via a PC or other IP device (e.g., through its interface 350).

According to one embodiment, the IP remote extender 410, when incorporated in the digital home communications system 400, may obtain a list of all devices (e.g., 31,32) that are connected to the network 24, 30 from the IP remote 10, and may learn what the associated IR/RF codes are for each of the devices 31, 32 (e.g., by consulting a look-up table stored in its memory 330).

According to one embodiment, the IP remote extender 410 may receive key commands from the IP remote 10 over a secured TCP/IP network.

According to one embodiment, the IP remote extender 410 may have a specified dedicated port 310 to which it will listen and retrieve key commands.

To reiterate, the present invention provides an IP remote control extender system (or IP remote extender) 410 for the remote control of electronic systems, particularly CE devices and home entertainment systems. In general, the IP remote extender 410 includes a wireless (e.g., IEEE 802.11b) input 310 for receiving IP based commands, means 320, 330, 331 for translating the commands to equivalent IR or RF based commands, and an output (i.e., IR or RF) 340 for transmitting the IR or RF based commands to non-IP based electronic systems (e.g., stereos 32, DVD players 31, etc.) for which remote control is desired.

The present invention provides several advantages. It provides an IP remote extender 410 that is flexible and virtually unlimited with respect to its control capabilities. The IP remote extender 410 does not require maintenance of line-of-sight to communicate with the IP remote 10. And, the IP remote extender 410 extends control capabilities to a virtually unlimited number of devices.

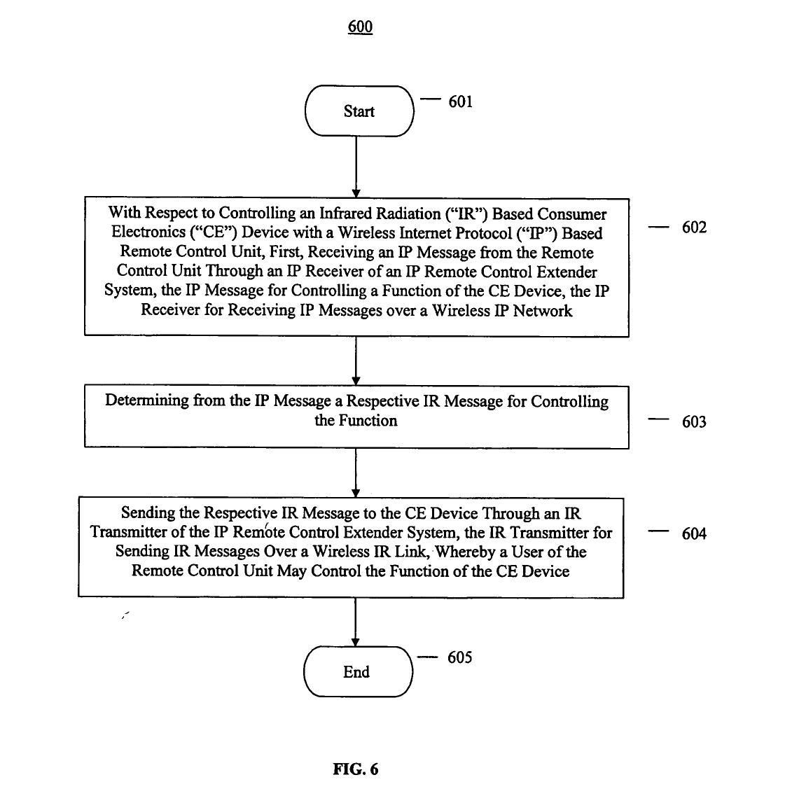

The above described method may be summarized with the aid of a flowchart. FIG. 6 is a flow chart illustrating operations 600 of modules 331 within the memory 330 of an IP remote control extender system 410 for controlling an infrared radiation (“IR”) based consumer electronics (“CE”) device (e.g., 32) with a wireless Internet Protocol (“IP”) based remote control unit 10, in accordance with an embodiment of the invention.

At step 601, the operations 600 start.

At step 602, an IP message (e.g., one or more IP packets containing commands, functions, etc.) is received from the remote control unit 10 through an IP receiver 310 of the IP remote control extender system 410, the IP message for controlling a function of the CE device 32, the IP receiver 310 for receiving IP messages over a wireless IP network 24.

At step 603, a respective IR message for controlling the function is determined from the IP message.

At step 604, the respective IR message is sent to the CE device 32 through an IR transmitter 340 of the IP remote control extender system 410, the IR transmitter 340 for sending IR messages over a wireless IR link, whereby a user of the remote control unit 10 may control the function of the CE device 32.

At step 605, the operations 600 end.

In the above method, the wireless IP network 24 may be an IEEE 802.11 based wireless fidelity (“Wi-Fi”) network. The IR based CE device 32 may be a radio frequency (“RF”) based CE device, the IR transmitter 310 may be a RF transmitter, and the IR message may be a RF message. The step of determining 603 may further include using content of the IP message to look up the IR message from a table of IP messages, IR messages, and IR based CE device identifiers, the table being stored in a memory 330 of the IP remote control extender system 410. The content of the IP message may include an identifier for the CE device and an identifier of the function. The method may further include populating the table by discovering the IR based CE device identifiers from the IP based remote control unit 10 using an IP based discovery protocol over the wireless IP network 24. The IP based discovery protocol may be a universal plug and play (“UPnP”) protocol. The method may further include populating the table by discovering the IR based CE device identifiers from each IR based CE device 32 using an IR based discovery algorithm over the wireless IR link. The IP remote extender system 410 may be included in a set-top box (“STB”) 20. And, the IR based CE device may be one or more of a set-top box (“STB”) 20, a stereo system 32, a video recorder (“VCR”), a digital video disk (“DVD”) player 31, a compact disk (“CD”) player, a stereo receiver, a tape deck, and a television (“TV”) 1.

According to one embodiment of the invention, the above described method may be implemented by the STB 20 rather than by the IP remote control extender system 410.

While this invention is primarily discussed as a method, a person of ordinary skill in the art will understand that the apparatus discussed above with reference to an IP remote control extender system 410, may be programmed to enable the practice of the method of the invention. Moreover, an article of manufacture for use with an IP remote control extender system 410, such as a pre-recorded storage device or other similar computer readable medium including program instructions recorded thereon, may direct the IP remote control extender system 410 to facilitate the practice of the method of the invention. It is understood that such apparatus and articles of manufacture also come within the scope of the invention.

In particular, the sequences of instructions which when executed cause the method described herein to be performed by the IP remote control extender system 410 of FIG. 5 can be contained in a data carrier product according to one embodiment of the invention. This data carrier product can be loaded into and run by the IP remote control extender system 410 of FIG. 5. In addition, the sequences of instructions which when executed cause the method described herein to be performed by the IP remote control extender system 410 of FIG. 5 can be contained in a computer software product according to one embodiment of the invention. This computer software product can be loaded into and run by the IP remote control extender system 410 of FIG. 5. Moreover, the sequences of instructions which when executed cause the method described herein to be performed by the IP remote control extender system 410 of FIG. 5 can be contained in an integrated circuit product (e.g., hardware modules) including a coprocessor or memory according to one embodiment of the invention. This integrated circuit product can be installed in the IP remote control extender system 410 of FIG. 5.

The embodiments of the invention described above are intended to be exemplary only. Those skilled in this art will understand that various modifications of detail may be made to these embodiments, all of which come within the scope of the invention.

What is claimed is:

1. A method for controlling an infrared radiation (“IR”) based consumer electronics (“CE”) device with a wireless Internet Protocol (“IP”) based remote control unit, the method comprising:
receiving an IP message from the remote control unit through an IP receiver of an IP remote control extender system, the IP message for controlling a function of the CE device, the IP receiver for receiving IP messages over a wireless IP network;
determining from the IP message a respective IR message for controlling the function; and,
sending the respective IR message to the CE device through an IR transmitter of the IP remote control extender system, the IR transmitter for sending IR messages over a wireless IR link, whereby a user of the remote control unit may control the function of the CE device.

2. The method of claim 1 wherein the wireless IP network is an IEEE 802.11 based wireless fidelity (“Wi-Fi”) network.

3. The method of claim 1 wherein the IR based CE device is a radio frequency (“RF”) based CE device, the IR transmitter is a RF transmitter, and the IR message is a RF message.

4. The method of claim 1 wherein the determining further comprises using content of the IP message to look up the IR message from a table of IP messages, IR messages, and IR based CE device identifiers, the table being stored in a memory of the IP remote control extender system.

5. The method of claim 4 wherein the content of the IP message includes an identifier for the CE device and an identifier of the function.

6. The method of claim 5 and further comprising populating the table by discovering the IR based CE device identifiers from the IP based remote control unit using an IP based discovery protocol over the wireless IP network.

7. The method of claim 6 wherein the IP based discovery protocol is a universal plug and play (“UPnP”) protocol.

8. The method of claim 5 and further comprising populating the table by discovering the IR based CE device identifiers from each IR based CE device using an IR based discovery algorithm over the wireless IR link.

9. The method of claim 1 wherein the IP remote extender system is included in a set-top box (“STB”).

10. The method of claim 1 wherein the IR based CE device is one or more of a set-top box (“STB”), a stereo system, a video recorder (“VCR”), a digital video disk (“DVD”) player, a compact disk (“CD”) player, a stereo receiver, a tape deck, and a television (“TV”).

11. A system for controlling an infrared radiation (“IR”) based consumer electronics (“CE”) device with a wireless Internet Protocol (“IP”) based remote control unit, the system comprising:
a processor coupled to memory, an IP receiver for receiving IP based messages over a wireless IP network, and an IR transmitter for sending IR based messages over a wireless IR link; and,
modules within the memory and executed by the processor, the modules including:
a module for receiving an IP message from the remote control unit through the IP receiver, the IP message for controlling a function of the CE device;
a module for determining from the IP message a respective IR message for controlling the function; and,
a module for sending the respective IR message to the CE device through the IR transmitter, whereby a user of the remote control unit may control the function of the CE device.

12. The system of claim 11 wherein the wireless IP network is an IEEE 802.11 based wireless fidelity (“Wi-Fi”) network.

13. The system of claim 11 wherein the IR based CE device is a radio frequency (“RF”) based CE device, the IR transmitter is a RF transmitter, and the IR message is a RF message.

14. The system of claim 11 wherein the determining further comprises using content of the IP message to look up the IR message from a table of IP messages, IR messages, and IR based CE device identifiers, the table being stored in a memory of the system.

15. The system of claim 14 wherein the content of the IP message includes an identifier for the CE device and an identifier of the function.

16. The system of claim 15 and further comprising a module for populating the table by discovering the IR based CE device identifiers from the IP based remote control unit using an IP based discovery protocol over the wireless IP network.

17. The system of claim 16 wherein the IP based discovery protocol is a universal plug and play (“UPnP”) protocol.

18. The system of claim 15 and further comprising a module for populating the table by discovering the IR based CE device identifiers from each IR based CE device using an IR based discovery algorithm over the wireless IR link.

19. The system of claim 11 wherein the system is included in a set-top box (“STB”).

20. The system of claim 11 wherein the IR based CE device is one or more of a set-top box (“STB”), a stereo system, a video recorder (“VCR”), a digital video disk (“DVD”) player, a compact disk (“CD”) player, a stereo receiver, a tape deck, and a television (“TV”).
